(19) United States
(12) Patent Application Publication
(10) Pub. No.: US 2018/0018631 A1
(43) Pub. Date: Jan. 18, 2018

(54) Reverse Digital Information Disbursement Method

(71) Applicant: James Elliott Aldridge, East Rutherford, NJ (US)

(72) Inventor: James Elliott Aldridge, East Rutherford, NJ (US)

(21) Appl. No.: 15/155,771

(22) Filed: Jul. 14, 2016

(51) Int. Cl. G06Q 10/10

(52) U.S. Cl. CPC G06Q 10/109

(57) ABSTRACT

Action 1—Design a database of information whose main overall title is considered the container-ID. In this database, create titled options that follow vertically one after the other.

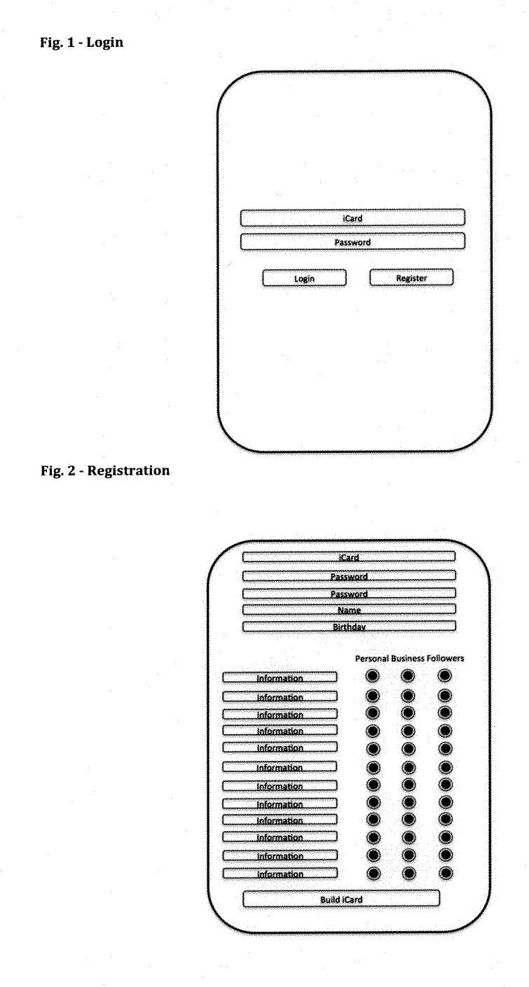

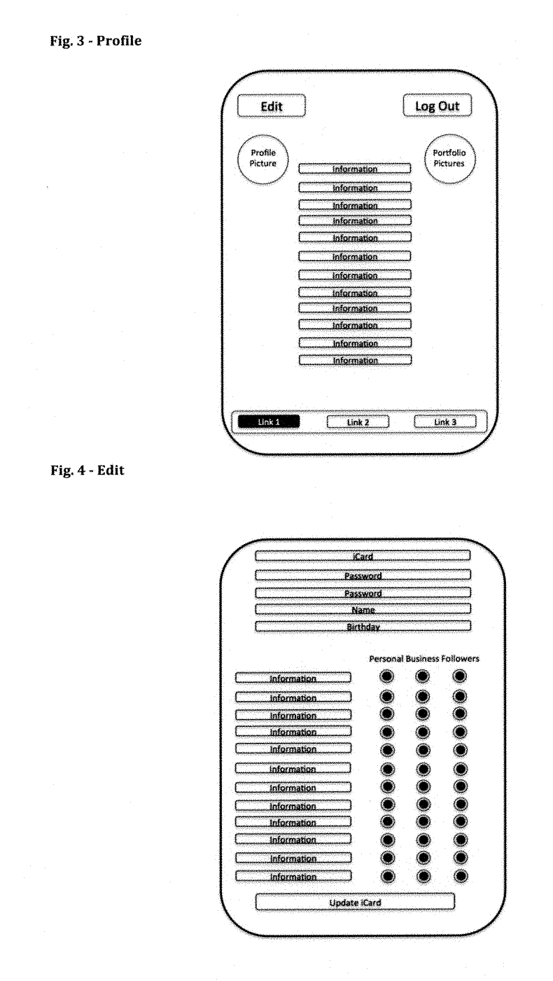

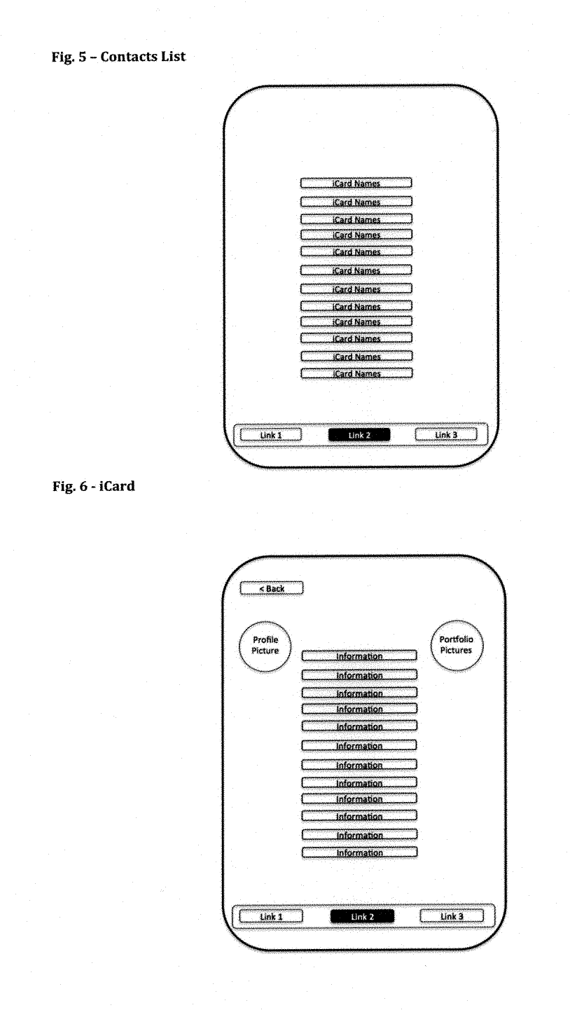

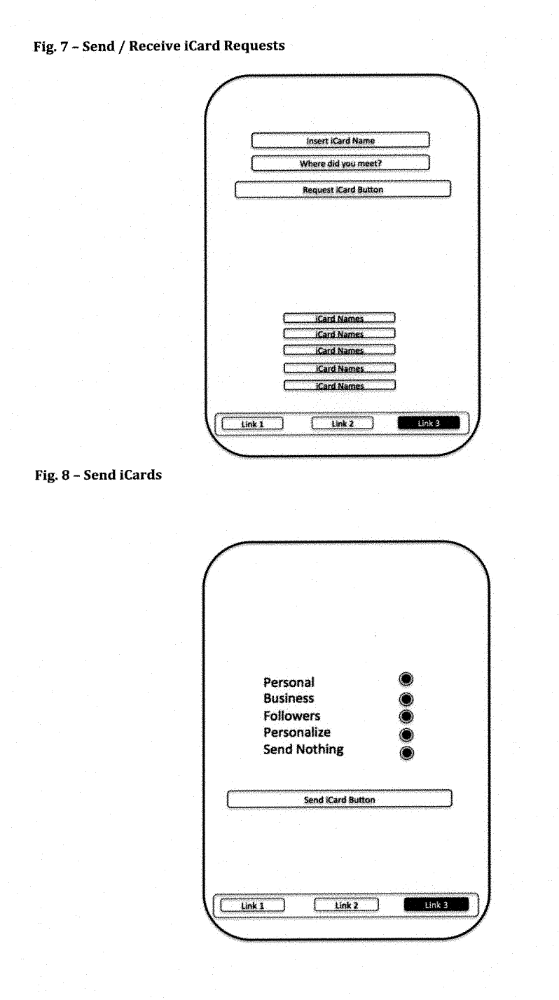

Action 2—Design a correlating database that has the ability to insert each single option into an unlimited amount of distinguished categories.

Action 3—Decide which options correlate with which categories.

Action 4—Design an online database that allows a user to sync their online profile with another user's online profile by providing the container-ID, which will allow for the owner of the container-ID to then send all of the information contained in the owner's options by the owner selecting which category that the owner would like to send to the recipient once the recipient has requested information from the owner.

Action 5—Send and receive the information.

### BACKGROUND OF INVENTION

### 1. Field of Invention

a. The digital world has many methods that are being used to disburse information. Often, the systems are based around a user accessing a method of searching for information stored on an external server. This control allows them to pick and choose which items of information they'd like to download.
b. If a single person wants to deliver digital information to another person, they may send them direct links to websites and downloadable data through any medium available. (i.e. Text Messages, eMail, Social Media etc . . . )
c. In the personal world of trading contact information, such as business cards and personal details, people find themselves either handing out paper business cards, flyers or using word of mouth to deliver information, which is to be saved through a number of possible mediums. People may store a business card in their wallet, contact information on their phones, or visit websites and save them to their favorite pages.
d. There is a missing product that incorporates the basic concepts of a, b and c, in reverse and uses new engineered and implemented attributes that are described below to create a new atmosphere to trading digital information.

R.D.I.D.M. (REVERSE DIGITAL INFORMATION DISBURSEMENT METHOD) allows the Owner of a Container-Name to give the Recipient the Container-Name, which the Recipient will use to Request information from the Owner of the Container-Name. This is to happen without the Recipient being able to browse the Owner's information. The Owner then has the control to send the Recipient the digital information (Options) that the Owner chooses.
i. Instead of the Recipient browsing the Owner's information.
ii. Instead of the Owner sending freely, simply because they know the Recipient's details. i.e. (eMail, Texts, Social Media etc . . . all have the option to send information if you know the other persons details.)
iii. Instead of distributing a physical object (Business Cards)

When the Recipient wants to allow the Owner to send the Recipient information, the Recipient can use the Container-Name to Request information from the Owner. The Owner then has complete control over what to send to the Recipient. This is to be done on a digital platform. Described below as a Smart-Phone Application that sends iCards, which are collections of contact details creating a digital page of information similar to a viewable interactive business card.

### BRIEF SUMMARY OF THE INVENTION

The invention (Portrayed in this Patent as the iCard phone application, but is not limited to the iCard iOS and Android phone application) is a digital medium that connects stored digital information to a Container-Name (iCard ID) that is to be requested by any person who is aware of that specific Container-Name (iCard ID). In this process, there are two active individuals using the invention: The Owner of the Container-Name (iCard ID) and the Recipient of the information.

Specific information connected to the Container-Name (iCard ID) is only transferred to the Recipient after the Owner (of the Container-Name) sends the Recipient the specific information attached to the Container-Name (iCard ID) by choosing which information to release only after the Recipient has first requested information from the Owner.

Presented through the iCard Phone Application there are three (but not limited to only three in future designs) distinct categories that are set up to determine what list of information should be sent to the Recipient from the Owner.

The first iCard category is labeled Business, and it establishes which information from the list of digital information is directly connected to the Business category. Therefore, if the Recipient is to ask the Owner for information (using an iCard Request), and the Owner chooses to only send Business related material to the Recipient, then the Recipient will receive all of the information connected to the Container-Name (iCard ID) that correlates with the Business category.

The second iCard category is labeled Personal, and it establishes which information from the list of digital information is directly connected to the Personal category. Therefore, if the Recipient is to ask the Owner for information (using an iCard Request), and the Owner chooses to only send Personal related material to the Recipient, then the Recipient will receive all of the information connected to the Container-Name (iCard ID) that correlates with the Personal category.

The third iCard category is labeled Followers, and it establishes which information from the list of digital information is directly connected to the Followers category. Therefore, if the Recipient is to ask the Owner for information (using an iCard Request), and the Owner chooses to only send Followers related material to the Recipient, then the Recipient will receive all of the information connected to the Container-Name (iCard ID) that correlates with the Followers category.

This idea can continue and grow to an unlimited amount of categories on multiple different platforms, all with different main focuses. For instance, if a Golf Club would like to alter the platform to suit their individual needs, the categories might be Golfers, Colleagues, and Personal. If the iCard is to be designed as an iCard Elite, it may contain categories based off of the types of digital information being sent. (i.e. .bmp, .png, .psd, etc . . . )

The main idea stays the same. An Owner of a Container-Name (iCard ID) gives out the Container-Name to a Recipient, who then requests the information by typing the Container-Name into the Request iCard option. Upon receiving the request, the Owner of the Container-Name selects which category of attributed digital information they would like to send to the Recipient.

The information that will be attached to the Container-Name (iCard ID) will have button selections in the registration and edit option, which will allow each item of digital information to be assigned to one or multiple categories. This will allow digital items (options) to be distinguished by categories. This distinguishing characteristic allows the Owner to send custom built iCards of multiple digital items to a single Recipient.

The iCard iOS and Android Phone Application is to become a method of sending and storing business cards for both personal and business use. The visible iCard language and icons will be modifiable, if someone seeks to use the technology's method, with different visible language and icons.

### DETAILED DESCRIPTION OF THE INVENTION

As of right now, there appears to be three commonly used methods of distributing more information than a single item vocally, one after the other, as in “Here's my number. Here's my Facebook. Here's my eMail. Etc . . . ” Those methods are: The old-fashioned static paper business card that includes as much or as little information about yourself that you choose. Google Vcards that allow you to send an electronic business card out via SMS text messaging and requires you to send all of the information available to any number of your choosing without truly determining the receiver's consent. And Apple's share contact details method, which requires you to send all of the information available to any number of your choosing without truly determining the receiver's consent.

All three methods include Person A having items to share with Person B. Person A then determines to share items with Person B and does so. And Person B having little to no ability to stop Person A from sending said details to them. For example: If Person A knows Person B's phone number, they can “share contact listing” (Apple) or (Google) with Person B without Person B's consent.

This implies that if Person A knows Person B's phone number, they can tell Person C Person B's phone number. Then Person C has access to send information to Person B. Possibly without Person B's consent.

The same goes for the standard old-fashioned static paper business card. Person A can pass out their business card to anyone they see, ultimately giving out their details instantly. In this case, if Person B receives Person A's business card, they can pass along that same business card to Person C. Meanwhile, Person A might not want Person C to have the same contact details that Person A gave to Person B. But, once Person A's business card is out in the open (given to Person B) then Person A no longer has control over what information is given to Person C from Person B.

The same is true for eMail. Once an eMail address is shared any person who has gained access to that eMail address can send information to the eMail inbox.

The same is true for phone numbers. Anyone who has gained access to a phone number may call that number at any time.

The same is true about websites. Anyone who has learnt a website's address may visit the website.

With the Reverse Digital Information Disbursement Method (R.D.I.D.M) none of the above is true. If Person A gives out the container-ID to Person B and Person B then gives the container-ID to Person C, Person C will not get any information from Person A without Person A's consent. There can be an infinite amount of options Person A has inside the container-ID that Person A has control to send to anyone who requests information from Person A using the container-ID. Therefore if Person B passes along the container-ID to Person C and Person C requests information from Person A, Person A can send completely different information to Person C than Person A sent to Person B.

This method prevents Person A from freely sending information to Person B until Person B requests information from Person A using the container-ID. Therefore, if Person A gives out the container-ID to Person B, Person B has no information from Person A stored on their systems, unless they choose to request information from Person A using the container-ID.

This prevents all forms of SPAM and third-party mishandling information, such as the selling of eMail addresses.

This method as of right now is displayed by using Android Studio and Xcode to create a Smartphone application called iCard, but should not be limited to Android Studio and/or Xcode productions. Using the Smartphone Application method allows the Reverse Digital Information Disbursement Method to gain notoriety amongst the general public and is used as a means to display the technological method.

However, future designs based around the technology concept are to come. Such as online stores that are only available if the owner of the container-ID clears you. Using R.D.I.D.M websites will be able to be given out in secrecy, protecting the creators from invasive amounts of traffic.

There are people who would be interested to know that they have the ability to send websites that are only attainable by certain people who they want to access those websites, such as artists who have a fan base who pay monthly for the quickest releases of items or tickets for sale. With R.D.I.D.M musicians and artists will be able to create multiple tiers for their fans, rather than just a single “pay X amount a month and gain access to our password protected environment”.

With R.D.I.D.M musicians will be able to give out the container-ID to their fans, and depending on how much the fan contributes to the band, they will be provided with more and more content, or a higher standard of access to the band's information that they'd like to distribute to the public.

This would in turn create a completely revolutionized method in which artists earn money. Instead of selling items for an exact amount, they could have a section of income that was completely voluntary from the public in the form of contributions. And the higher the contribution, the better the information the artist chooses to send to them.

### Improvements:

RDIDM provides a method that allows for everyone in the world to know Person A's container-ID and receive no information from or send no information to Person A without Person A's consent. (Unlike previously where Person B, C, D, etc . . . could send information to person A as long as they found a way to access their contact details. In the past, the sender only needs to have the receiver's information, and there is little to protect the receiver from receiving the information the sender wants to send. For example eMail and eMail Addresses, if the sender has someone's eMail address, they can eMail the receiver anything they choose. Same is true with cell phone numbers, if you have someone's phone number you can text them without their consent.)

RDIDM provides a double checked verification method (By the receiver and the sender) that allows for Person A to send to each Person, who would like information from Person A, an unlimited amount of information however Person A chooses to send that information, only after Person B agrees for Person A to be able to do so by accepting the container-ID and requesting information from Person A. (Unlike previously where Person B, C, D, etc . . . could send information to person A as long as they found a way to access their contact details. The sender only needs to have the receiver's information, and there is little to protect the receiver from receiver the information the sender wants to send. For example eMail and eMail Addresses, if the sender has someone's eMail address, they can eMail the receiver anything they choose. Same is true with cell phone numbers, if you have someone's phone number you can text them without their consent.)

For example, if someone is given a Container-ID, they are essentially given no contact information at all that can be sold as a product that can be used by a third party for advertising purposes. They are also not given any information in which they can abuse. As well, if they are to request information from the Owner of the Container-ID that person will receive no information about the person requesting the information. This means that items are double protected from reaching the hands of other people.

RDIDM allows for the owner of the container-ID to distinguish which information is to be sent to each different recipient. (Unlike previously where a single area that was protected by a password registration method allowed users to all contain access to the same area, such as a members only website. Or, a business card was traded through Apple's method, where all the information had to be sent)

RDIDM allows for multiple platforms to be used to allow for the transfer of information. (Unlike previously where Apple only trades contact information on Apple Phones. The iCard Smartphone application uses the RDIDM platform and has the ability to send information on any phone that can handle the application. Systems can be designed to send information through the RDIDM platform that branch different systems from PC to MAC from Hand Held Device to Home Computer etc . . . )

1. A Database of digital information (iCard Database), which is Operated by an Owner and given a Container-Name (iCard ID) is to store accessible data in multiple categories that can only be accessed once the Owner allows the Recipient to access the Options assigned to the specific Categories that the Owner allows the Recipient to view once the Recipient has Requested information from the Owner.

2. For the Owner to have the ability to send the Recipient specific Categories of Options, the Recipient must first know the Container-Name. Then, using the Container-Name, the Recipient must send a Request (iCard Request) to the Owner before the Owner has the opportunity to send information.
*Depends on claim 1 by showing the means in which the Recipient is allowed access to view the Owner's options.

3. The Database (iCard database) mentioned in claim 1 is not limited to a specific number of Options and is not to be restricted specifically to what is presented through the iCard iOS and Android Smartphone Application. The database is meant to be adaptable and extendable as far as chosen.
*Depends on claim 1 and demonstrates the flexibility of the database mentioned in claim 1.

4. The Options mentioned in claim 3 can either have a determined Title and an editable Description or they can have an editable Title and an editable Description.
*Depends on claim 3 and demonstrates the structural flexibility of the database mentioned in claim 3.

5. The Descriptions mentioned in claim 4 can be any form of digital media (text, links, downloadable files, images, video, etc . . . ).
*Depends on claim 4 and demonstrates the flexibility of the types of files allowed to be in the Descriptions aspect of the said database.

6. The Titles and Descriptions mentioned in claim 4 are the accessible details presented to the Recipient.
*Depends on claim 4 and merely clarifies what is presented to the Recipient.

7. The information that is contained inside each Option will have the ability to auto-update on the Recipient's end if and after the Owner of the Container-ID edits the Option on the Owner's end.
*Depends on claim 3 and demonstrates how the database is a live database.

8. The Database (iCard Database) mentioned in claim 1 can be divided into as many categories as chosen.
*Depends on claim 1 and states the databases' ability to grow in contrast to being a fixed database design.

9. The Categories, mentioned in claim 7, are the method of distinguishing what information attached to the Container Name (iCard ID) is sent out to the Recipient. This is done so by the Owner assigning the information to one or multiple categories. Then, once the Recipient has sent an iCard Request, the Owner selects which categories the Recipient is to receive.
Depends on claim 7, claim 1 and demonstrates the meaning of the usage of different categories inside the said Database.

10. The R.D.I.D.M. is initiated after the Recipient types the Container-Id into the Send Request text box and pushes the Send Request button.
*Depends on claim 1 and demonstrates when claim 1 is put into effect.

11. Although R.D.I.D.M (REVERSE DIGITAL INFORMATION DISBURSEMENT) is presented first as a Smartphone application entitled iCard, and will be primarily used to generate Business, Personal and Followers' iCards using primarily texts and links, the technology is not limited to this single Smartphone application concept. The Independent claim #1 is designed to protect an adaptable and growing concept of disbursing information, which is merely described here using the iCard platform.

12. The R.D.I.D.M. process will utilize both stationary categories for quick sends of completed digital information groups such as that shown above as “Business, Personal and Followers” categories, as well as a self-designed “on-the-spot” adaptable category, which will allow users to generate selections in the moment to send an even more specific group of information to each select individual.
